(19) United States
(12) Patent Application Publication
(10) Pub. No.: US 2026/0241821 A1
(43) Pub. Date: Aug. 20, 2026

(54) A SELF-PROPELLED DEVICE, WORKING ROBOT AND CHARGING SYSTEM

(71) Applicant: SHENZHEN HANYANG TECHNOLOGY CO., LTD., Shenzhen, Guangdong (CN)

(72) Inventors: Yang HUANG, Shenzhen, Guangdong (CN); Taotao ZHU, Shenzhen, Guangdong (CN); Yongqi SONG, Shenzhen, Guangdong (CN); Dong CHEN, Shenzhen, Guangdong (CN); Weiyue CHEN, Shenzhen, Guangdong (CN)

(21) Appl. No.: 18/838,943

(22) PCT Filed: Dec. 1, 2023
(86) PCT No.: PCT/CN2023/135923

§ 371 Date: Aug. 15, 2024

(30) Foreign Application Priority Data
Jun. 16, 2023 (CN) 202310725079.3
Aug. 8, 2023 (CN) 202322118614.7

(51) Int. Cl. B60L 53/38; B60L 53/12; E01H 5/09; H02J 50/00; H02J 50/10; H02J 50/90

(52) U.S. Cl. CPC B60L 53/38; B60L 53/12; H02J 50/005; H02J 50/10; H02J 50/90; B60L 2200/40; E01H 5/098

(57) ABSTRACT

This application discloses a self-propelled device, a working robot and a charging system. The self-propelled device is suitable for charging through a charging pile. The self-propelled device includes a vehicle body, a traveling mechanism, a battery and a charging module. The traveling mechanism is provided at the bottom of the vehicle body and is used to drive the vehicle body to move and perform work. The battery is mounted on the vehicle body. The charging module is configured to couple with the charging pile to receive electric energy from the charging pile to charge the battery, the charging module being disposed at the bottom of the vehicle body. Therefore, the working robot and charging pile adopt a bottom-up charging structure, and the entire vehicle body can cover the charging module located at the bottom of the body. When the working robot works outdoors in snowy weather, the vehicle body can prevent snowflakes from falling on the surface of the charging module, thus solving the problem of difficulty in charging caused by snow accumulation or lumps on the surface of the charging module, ensuring that the working robot can successfully complete the charging task.

### CROSS-REFERENCES TO RELATED APPLICATIONS

This application claims priority to the Chinese patent application with application number CN202310725079.3 and titled “Snow Clearing Robot and Snow Clearing System” submitted to the China Patent Office on Jun. 16, 2023, the entire content of which is incorporated into this application by reference.

This application claims priority to the Chinese patent application with application number CN202322118614.7 and titled “Mobile Robot with Wireless Charging Function” submitted to the China Patent Office on Aug. 8, 2023, the entire content of which is incorporated into this application by reference.

### TECHNICAL FIELD

The present application relates to the field of robotic technology, and more specifically, to a self-propelled device, a working robot and a charging system.

### BACKGROUND TECHNIQUE

With the rapid development of robotic technology, household robots (such as snow clearing robots) have begun to enter every corner of life. Among them, the snow clearing robot includes a snow clearing device and a carrier used to drag the snow clearing device to move in the courtyard. The carrier is usually a wheeled or crawler tracked vehicle body. The snow clearing device mainly includes a snow rolling mechanism and a snow throwing mechanism. The snow rolling mechanism collects the snow on the ground into the snow rolling cabin, and then throw the snow in the snow rolling cabin in the specified direction through the snow throwing mechanism.

In order to pursue the concept of low-carbon, environmental protection, energy conservation and emission reduction, traditional snow clearing robots that rely on fuel as power are gradually being eliminated. The development direction of existing snow clearing robots mainly adopts electric structures powered by batteries. The existing charging module is mainly installed on the side of the vehicle body of the snow clearing robot, and the movement of the snow clearing robot brings the charging module on the side of the vehicle body closer to the charging pile in order to achieve electrical connection with the charging pile.

Since snow clearing robots usually perform snow clearing work when it snows, the vehicle body of the snow clearing robot is easily covered by snowflakes or hard snow lumps are formed on the surface of the vehicle body, which brings great difficulties in charging the snow clearing robot.

### BRIEF SUMMARY OF THE INVENTION

Embodiments of the present application provide a self-propelled device, a working robot and a charging system.

According to a first aspect of the present application, an embodiment of the present application provides a self-propelled device, which is suitable for charging through a charging pile. The self-propelled device includes a vehicle body, a traveling mechanism, a battery and a charging module. Among them, the traveling mechanism is provided at the bottom of the vehicle body and used to drive the vehicle body to move and perform work, and the battery is mounted on the vehicle body. The charging module is configured to couple with the charging pile to receive electric energy from the charging pile to charge the battery. The charging module is disposed at the bottom of the vehicle body.

According to the second aspect of the present application, an embodiment of the present application also provides a working robot, which includes a working device and the above-mentioned self-propelled device, and the working device is connected to the vehicle body of the self-propelled device.

According to the third aspect of the present application, an embodiment of the present application further provides a charging system, which includes the above-mentioned working robot and a charging pile. Wherein, the charging pile includes a base and a power module. The power module is arranged on the base and is adapted to the charging module of the working robot. The base is used for parking the working robot. When the working robot is parked at the base for charging, the power module is located below the charging module.

### DESCRIPTION OF DRAWINGS

In order to more clearly illustrate the technical solutions in the embodiments of the present application, the drawings needed to be used in the description of the embodiments will be briefly introduced below. Obviously, the drawings in the following description are only some embodiments of the present application. For those skilled in the art, other drawings can also be obtained based on these drawings without exerting creative efforts.

FIG. 1 is a schematic structural diagram of a charging system provided by an embodiment of the present application.

FIG. 2 is a schematic structural diagram of the charging pile in the charging system shown in FIG. 1.

FIG. 3 is a schematic structural diagram of the working device in the charging system shown in FIG. 1.

FIG. 4 is a schematic structural diagram of the self-propelled device in the charging system shown in FIG. 1.

FIG. 5 is a schematic cross-sectional structural diagram of the self-propelled device shown in FIG. 4.

FIG. 6 is an exploded structural diagram of the charging module in the self-propelled device shown in FIG. 4.

FIG. 7 is a schematic structural diagram of the charging module in an installed state in the self-propelled device shown in FIG. 4.

FIG. 8 is a schematic structural diagram of the charging module in a disassembled state in the self-propelled device shown in FIG. 4.

FIG. 9 is a schematic structural diagram of the vehicle body, the charging module and the lock assembly of the self-propelled device shown in FIG. 4.

FIG. 10 is an exploded structural diagram of the lock assembly shown in FIG. 9.

FIG. 11 is a schematic cross-sectional structural diagram of the lock assembly shown in FIG. 9.

Label description: 10, charging system; 20, charging pile; 210. base; 230, power module; 2320, transmitting coil; 30, working robot; 320, working device; 3200, snow clearing device; 3201, case; 3210, snow rolling mechanism; 3212, snow rolling cabin; 3214, snow rolling blades; 3216, snow rolling output shaft; 3230, snow throwing mechanism; 3232, snow throwing cabin; 340, self-propelled device; 3410, vehicle body; 3412, bottom surface; 3414, receptacle cavity; 3416, inner wall; 3418, clamping hole; 3420, traveling mechanism; 3421, crawler track; 3430, battery; 3490, baffle mechanism; 3492, baffle; 3460, driving member; 3440, charging module; 3441, receiving coil; 3443, coil positioning sensor; 3445, inductor; 3447, charging circuit board; 2340, marking coil; 3470, control module; 3450, housing; 3451, charging surface; 3454, upper housing; 3455, lower housing; 3456, sealing member; 3480, limiting mechanism; 3481, first limiting portion; 3482, second limiting portion; 3483, limiting protrusion; 3484, limiting groove; 3500, lock assembly; 3510, shell; 3512, support; 3514, cover; 3516, through hole; 3520, lock tongue; 3521, clamping part; 3530, elastic member; 3532, spring; 3540, guide post; 3518, guide platform; 3523, guide groove; 3453, fixing platform; 3550, lug; 3552, penetration hole; 3560, fastener; 3234, snow throwing bucket.

### DETAILED DESCRIPTION

In order to enable those skilled in the art to better understand the solution of the present application, the technical solution in the embodiment of the present application will be clearly and completely described below in conjunction with the drawings in the embodiment of the present application. Obviously, the described embodiments are only some of the embodiments of the present application and not all of the embodiments. Based on the embodiments in this application, all other embodiments obtained by those skilled in the art without creative efforts shall fall within the scope of protection of this application.

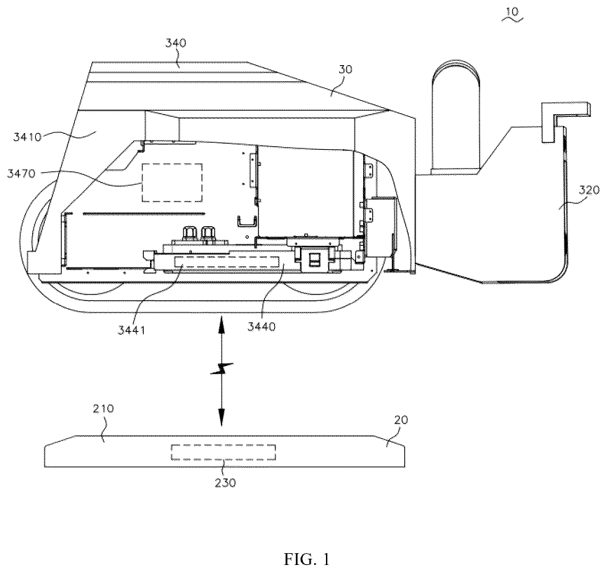

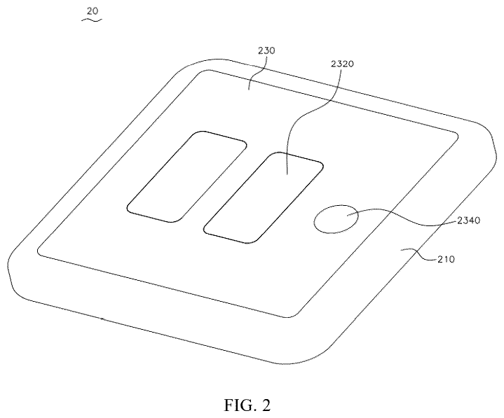

Referring to FIGS. 1 and 2, this embodiment discloses a charging system 10. The charging system 10 may include a charging pile 20 and a working robot 30, wherein the working robot 30 is adapted to be electrically connected to the charging pile 20 so that the charging pile 20 can charge the working robot 30.

In this embodiment, the charging pile 20 may include a base 210 and a power module 230, wherein the base 210 is used for parking the working robot 30. The power module 230 is arranged on the base 210, and the base 210 can also play a role in fixing and protecting the power module 230. Specifically, the power module 230 is adapted to the charging module 3440 of the working robot 30. For example, the power module 230 may include a transmitting coil 2320, and the charging module 3440 may include a receiving coil 3441 coupled with the transmitting coil 2320. The receiving coil 3441 can receive electromagnetic waves emitted by the transmitting coil 2320 to achieve wireless charging between the charging pile 20 and the working robot 30. As another example, the power module 230 may include a plug (for example, a plug with pins), and the charging module 3440 may include a socket that is adapted to the plug. For example, the socket may be a conductive plate. When the plug is held against the conductive plate through the pins, wired charging between the charging pile 20 and the working robot 30 can be achieved.

In some possible embodiments, when the power module 230 includes a transmitting coil 2320, the power module 230 may also include a frequency converter (not shown in the figure), wherein the transmitting coil 2320 is connected through a frequency converter to the power supply that inputs electricity to the charging pile, and the frequency of the input voltage is adjusted through the frequency converter. If the input voltage is alternating current, the frequency of the alternating current voltage is adjusted through the frequency converter to control the charging efficiency of the working robot 30. If the input voltage is direct current, the power module 230 also includes an oscillation circuit (not shown in the figure), through which the input direct current is filtered to form a pulsating direct current; the frequency of the pulsating direct current is changed through a frequency converter to control the charging efficiency of working robot 30. Specifically, the frequency converter may include a rectification unit, a filter unit, an inverter unit, a braking unit, a micro processing unit, etc., and the oscillation circuit may be an LC oscillation circuit. This embodiment does not limit the specific implementation methods of the frequency converter and the oscillation circuit.

In this embodiment, the working robot 30 may include a working device 320 and a self-propelled device 340, wherein the working device 320 is connected to the vehicle body 3410 of the self-propelled device 340, and the working device 320 is used to implement different functions corresponding to the working robot 30. For example, when the working robot 30 is a snow clearing robot, the working device 320 can be a snow removal mechanism, a snow pushing mechanism, etc. ; for another example, when the working robot 30 is a weeding robot, the working device 320 can be a weeding mechanism, a mowing mechanism and so on. Specifically, the working device 320 may be a snow removal mechanism, a snow rolling mechanism, a snow throwing mechanism, a weeding mechanism, a mowing mechanism, a leaf blowing mechanism, a salt spreading mechanism, a rolling brush mechanism, a snow pushing mechanism, etc. This embodiment does not limit the specific implementation method of working device 320. The self-propelled device 340 is used to drag the working device 320 to perform work. The self-propelled device 340 is provided with the above-mentioned charging module 3440, so that the self-propelled device 340 is suitable for charging through the charging pile 20.

In some possible embodiments, the working device 320 may be a snow clearing device 3200. The snow clearing device 3200 is used to clear snow on the road. The snow clearing device 3200 in this embodiment may include a snow rolling mechanism 3210 and a snow throwing mechanism 3230, wherein the snow rolling mechanism 3210 is provided with a snow rolling cabin 3212, and the snow rolling blade 3214 is provided inside the snow rolling cabin 3212 for collecting snow. The snow throwing mechanism 3230 is provided with a snow throwing cabin 3232 connected with the snow rolling cabin 3212, and the snow throwing blade (not shown in the figure) is provided inside the snow throwing cabin 3232 for throwing the snow in the snow rolling cabin 3212. Among them, the snow throwing cabin 3232 is located on the central axis of the snow rolling cabin 3212, the snow rolling blades 3214 are fixed on the snow rolling output shaft 3216, and the snow rolling blades 3214 are arranged in two groups symmetrically about the central axis of the snow rolling cabin 3212. The spiral guide of each set of snow rolling blades 3214 is directed towards the central axis of the snow rolling cabin 3212. Therefore, when the snow rolling output shaft 3216 rotates, it will drive two sets of snow rolling blades 3214 to simultaneously accumulate the snow in the snow rolling cabin 3212 toward the center of the snow rolling cabin 3212. As the working robot 30 continues to advance, the snow accumulated in the center of the snow rolling cabin 3212 is pushed to the depth of the snow rolling cabin 3212 by the continuous influx of new snow, that is, the accumulated snow is pushed to the snow throwing cabin 3232 connected to the snow rolling cabin 3212, and the accumulated snow is thrown out along the snow throwing bucket 3234 through the work of the snow throwing blades.

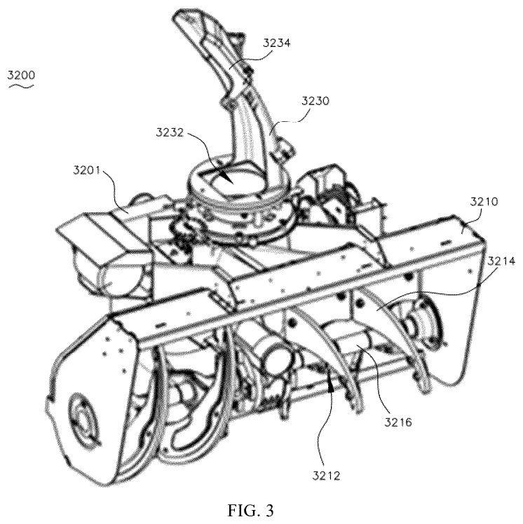

Specifically, in the embodiment shown in FIG. 3, the snow rolling cabin 3212 has a semi-enclosed structure and opens toward the front. In this way, when the working robot 30 is traveling, the snow rolling cabin 3212 will pocket the oncoming snow into it. A snow throwing cabin 3232 is provided on the side of the snow rolling cabin 3212 away from the opening. A snow throwing bucket 3234 connected with the snow throwing cabin 3232 is provided on the outside of the snow clearing device 3200. The inside of the snow rolling cabin 3212 is a curved inner cavity, and the cross section of the inner cavity gradually narrows from the opening to the snow throwing cabin 3232. In this way, the snow rolling blades 3214 gather together the accumulated snow in the snow rolling cabin 3212. As the working robot 30 advances, the snow accumulated in the snow rolling cabin 3212 is gathered by the cabin wall of the snow rolling cabin 3212 with a gradually reduced cross-section and rushes to the snow throwing cabin 3232, and then is thrown out from the snow throwing bucket 3234 through the snow throwing blades of the snow throwing cabin 3232.

In some possible embodiments, the snow clearing device 3200 may also include a driving member (not shown in the figure) for driving the snow rolling blade 3214 and the snow throwing blade. For example, the driving member may be a motor. The motor is powered by the battery 3430 provided in the self-propelled device 340. In this way, compared with traditional fuel-powered snow clearing robots, the size of the drive system of the working robot 30 disclosed in this embodiment can be smaller, achieving the miniaturization of the working robot 30.

Further, the root of the snow throwing bucket 3234 is fixedly connected to the case 3201 of the snow clearing device 3200. The snow throwing bucket 3234 is arc-shaped, and its end extends in the vertical direction while gradually bends in the horizontal direction. In order to achieve the longest snow throwing lift under limited energy consumption, the central angle of the center line of the snow throwing bucket 3234 in this embodiment is 45°, that is, at the moment when the accumulated snow leaves the snow throwing port, the angle between the velocity direction and the horizontal direction is 45°. Because, for the same mass of accumulated snow with the same initial velocity, the snow will be thrown the farthest in the horizontal direction when it is thrown upwards at an angle of 45°. Therefore, using such a structural design, under the premise that the energy consumption remains unchanged (that is, the initial velocity when the snow leaves the snow throwing port remains unchanged), the maximum snow throwing lift can be obtained, and the snow can be thrown farther, improving the snow throwing efficiency of the working robot 30 and reducing the energy consumption of the working robot 30.

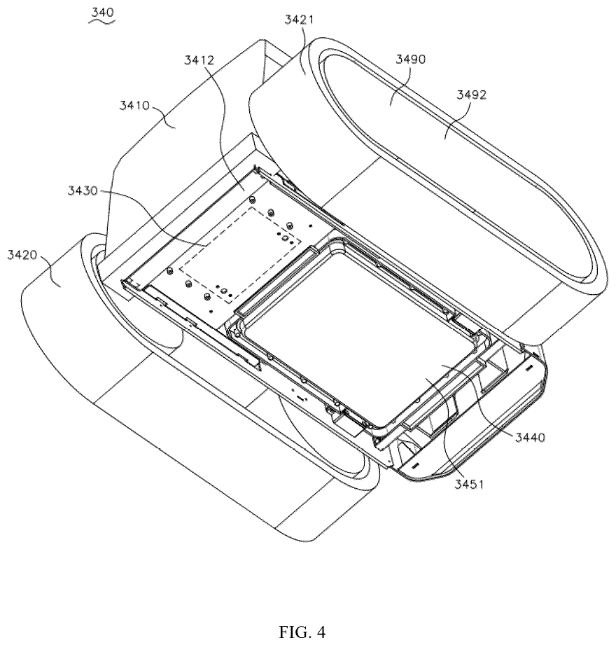

Referring to FIG. 4, the self-propelled device 340 may include a vehicle body 3410, a traveling mechanism 3420, a battery 3430 and a charging module 3440. Among them, the traveling mechanism 3420 is provided at the bottom of the vehicle body 3410 and is used to drive the vehicle body 3410 to move and perform work. The battery 3430 is mounted on the vehicle body 3410. The charging module 3440 is configured to couple with the charging pile 20 to receive electric energy from the charging pile 20 to charge the battery 3430. The charging module 3440 is disposed at the bottom of the vehicle body 3410.

Since the charging module 3440 is disposed at the bottom of the vehicle body 3410, when the working robot 30 is parked at the base 210 of the charging pile 20 for charging, the power module 230 is located below the charging module 3440. Therefore, this application adopts a bottom-up charging structure of the power module 230 and the charging module 3440, and the entire vehicle body 3410 can shield the charging module 3440 located at the bottom of the vehicle body 3410. When the working robot 30 works outdoors in snowy weather, the vehicle body 3410 can prevent snowflakes from falling on the surface of the charging module 3440, thus solving the problem of difficulty in charging caused by snow accumulation or lumps on the surface of the charging module 3440, ensuring that the working robot 30 can successfully complete the charging task.

The structure of the self-propelled device 340 is introduced in detail below.

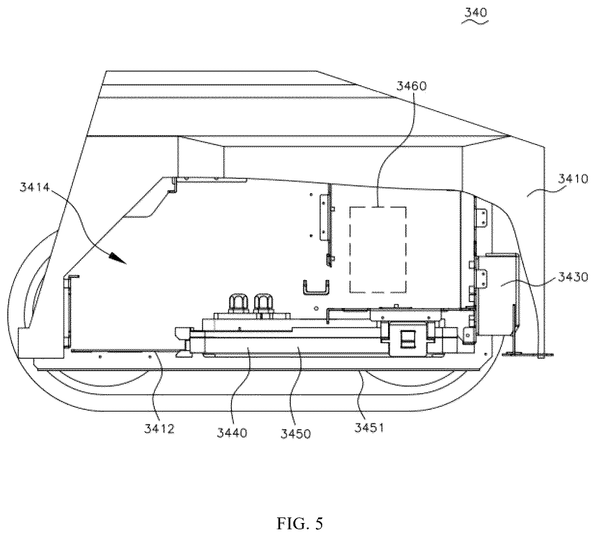

In this embodiment, the vehicle body 3410 is used to fix and support the battery 3430 and the charging module 3440. Please refer to FIG. 5. The vehicle body 3410 can be provided with a receptacle cavity 3414. The receptacle cavity 3414 is roughly located at the bottom of the vehicle body 3410. The battery 3430 and the charging module 3440 can be disposed in the receptacle cavity 3414 to protect the battery 3430 and the charging module 3440.

In this embodiment, the battery 3430 is mounted on the vehicle body 3410. On the one hand, the battery 3430 is electrically connected to the traveling mechanism 3420 and is used to provide the electric energy required for the self-propelled device 340 to walk. On the other hand, the battery 3430 is also electrically connected to the working device 320 and is used to provide the electric energy required to drive the working device 320 to work. Specifically, the battery 3430 may be a lead-acid battery, a nickel-metal hydride battery, a lithium-ion battery, etc., which is not specifically limited in this embodiment.

In this embodiment, the traveling mechanism 3420 is provided at the bottom of the vehicle body 3410 and is used to drive the vehicle body 3410 to move and perform work. Specifically, the traveling mechanism 3420 is disposed at the bottom of the vehicle body 3410 and supports the vehicle body 3410 so that the bottom of the vehicle body 3410 is spaced apart from the surface of the walking scene, and the charging module 3440 is exposed at the bottom of the vehicle body 3410. Therefore, when the working robot 30 travels above the charging pile 20, the charging module 3440 located at the bottom of the vehicle body 3410 can maintain a certain distance from the charging pile 20 to avoid collision between the charging module 3440 and the charging pile 20.

In some possible embodiments, please refer to FIG. 4 again, the traveling mechanism 3420 may include two crawler tracks 3421, the two crawler tracks 3421 are located on the left and right sides of the vehicle body 3410 in the direction of travel, and the charging module 3440 is exposed in the space between the two crawler tracks 3421. Therefore, during the movement of the vehicle body 3410, the two crawler tracks 3421 located on both sides of the vehicle body 3410 can, to a certain extent, prevent snow from pouring into the bottom of the vehicle from the left and right sides of the vehicle body 3410, thereby preventing the snow from the ground from contacting with the charging module 3440 and reducing the probability of the surface of the charging module 3440 being covered with snow lumps or ice lumps due to snow on the ground, so as to ensure that the self-propelled device 340 can be charged smoothly. In some other possible embodiments, the traveling mechanism 3420 may include multiple driving wheels, and the multiple driving wheels may be disposed at the bottom of the vehicle body 3410 to drive the vehicle body 3410 to move and work. This embodiment does not specifically limit the implementation of the traveling mechanism 3420.

In some possible embodiments, the self-propelled device 340 also includes a baffle mechanism 3490. The baffle mechanism 3490 includes two baffles 3492. The two baffles 3492 are respectively arranged on the sides of the two crawler tracks 3421 and cover the space between the two crawler tracks 3421. Therefore, when the vehicle body 3410 travels in the snow, the two baffles 3492 and the two crawler tracks 3421 can further prevent the accumulated snow on the ground from pouring into the bottom of the vehicle from the bottoms on both sides of the vehicle body 3410. In addition, the working device 320 located in front of the vehicle body 3410 can also prevent the accumulated snow on the ground from pouring into the bottom of the vehicle from the front of the vehicle body 3410, so that the baffle 3492, the crawler track 3421 and the working device 320 form a three-sided enclosure structure for the bottom of the vehicle body 3410. Even if the self-propelled device 340 travels on snow with a certain thickness, the snow cannot flow into the bottom of the vehicle through the two sides and front of the vehicle body 3410, thereby preventing the snow from the ground from contacting with the charging module 3440, and reducing the probability of the surface of the charging module 3440 being covered with snow lumps or ice lumps due to snow on the ground, so as to ensure that the self-propelled device 340 can be charged smoothly.

Furthermore, when encountering a snowstorm, since the baffle 3492, the crawler track 3421 and the working device 320 can completely cover both sides and the front of the bottom of the vehicle body 3410, it is difficult for the snowflakes blown up by the wind to enter the bottom of the vehicle. In this way, snowflakes from the sky and the ground cannot reach the charging module 3440, which facilitates automatic charging of the self-propelled device 340.

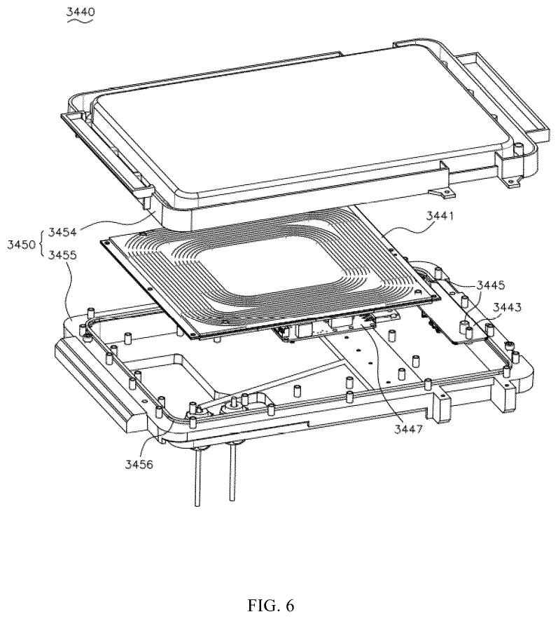

In this embodiment, the charging module 3440 is configured to couple with the charging pile 20 to receive electric energy from the charging pile 20 to charge the battery 3430. Referring to FIG. 6, the charging module 3440 may include a housing 3450 and a receiving coil 3441. The housing 3450 is installed at the bottom of the vehicle body 3410. The receiving coil 3441 is configured to couple with the transmitting coil 2320 located at the charging pile 20. The receiving coil 3441 is disposed within the housing 3450 and is electrically connected to the battery 3430.

Therefore, the charging pile 20 and the working robot 30 in this embodiment are charged using wireless charging. Compared with traditional wired connections, such as contact connections between pins and conductive plate, wireless charging avoids problems such as poor contact of electrical contact components (e.g., plugs, sockets) caused by rust, dust, dirt and wear and tear. In addition, compared with direct plug-in charging, since there is no plug, manual intervention is not required. The working robot 30 can perform wireless charging by driving to the corresponding position of the charging pile 20, eliminating the need to manually insert the charging connector, allowing the charging process to be automated.

In some possible embodiments, the charging module 3440 may also include a charging circuit board 3447 and the receiving coil 3441 is electrically connected to the battery 3430 through the charging circuit board 3447. Specifically, the charging circuit board 3447 can be integrated with circuit structures such as a rectifier circuit, a filter circuit, and a voltage stabilizing circuit, so that the receiving coil 3441 rectifies, filters and stabilizes the induced voltage through the charging circuit board 3447 to charge the battery 3430, so that the charging process can proceed smoothly.

In this embodiment, the housing 3450 can provide a good sealed space to protect the internal components and prevent the internal components (for example, the receiving coil 3441) from being eroded by external environments such as rain, snow, wind, sand, moisture, etc. Specifically, the housing 3450 may include an upper housing 3454 and a lower housing 3455 that are connected to each other. The upper housing 3454 and the lower housing 3455 are engaged with each other to form a sealed space for accommodating the receiving coil 3441 and the charging circuit board 3447.

Since the receiving coil 3441 and the charging circuit board 3447 inside the charging module 3440 are prone to heat generation, the charging module 3440 requires good heat dissipation. To solve the above problem, one of the upper housing 3454 and the lower housing 3455 includes a plastic material, and the other includes a metal material. Among them, the metal housing has high thermal conductivity and can quickly dissipate the heat inside the charging module 3440; the plastic housing can prevent metal from blocking the charging module 3440 when the charging module 3440 is receiving the magnetic field, so that the receiving coil 3441 can work normally. The housing 3450 in this embodiment adopts a combination of metal and plastic, which not only has good receiving ability, but also has heat dissipation properties, so that the internal components can work in a stable environment and extend the service life of the internal components.

Specifically, the upper housing 3454 is located on the side of the housing 3450 facing the charging pile 20, and the upper housing 3454 is made of plastic material (for example, thermoplastic plastic, thermosetting plastic, etc.). The lower housing 3455 is located on the side of the housing 3450 away from the charging pile 20, and is made of metal (for example, alloy, stainless steel, etc.). Therefore, when the working robot 30 is charging, the upper housing 3454 is located between the charging pile 20 and the receiving coil 3441, and there will be no problem that the magnetic field generated by the receiving coil 3441 is blocked by the plastic upper housing 3454. The lower housing 3455 is located on the side of the receiving coil 3441 away from the charging pile 20, which can quickly dissipate the heat generated by the receiving coil 3441 due to electromagnetic induction, thus ensuring the smooth operation of the charging module 3440.

In some possible embodiments, the housing 3450 may also include a sealing member 3456, and the upper housing 3454 and the lower housing 3455 are sealed via the sealing member 3456. The sealing member 3456 can improve the sealing effect of the housing 3450 to prevent rain, snow, wind, sand, moisture, etc. from entering the interior of the housing 3450, and further ensure the stability of the working environment of the internal components of the housing 3450. Specifically, the sealing member 3456 may be a sealing ring or a sealing strip.

In some possible embodiments, the charging module 3440 may also include a coil positioning sensor 3443. The coil positioning sensor 3443 is disposed within the housing 3450. The coil positioning sensor 3443 is configured to detect the position of the charging module 3440 relative to the charging pile 20. In this embodiment, the coil positioning sensor 3443 detects changes in the magnetic field of the charging pile 20 to determine the distance and angle of the charging module 3440 relative to the charging pile 20, thereby identifying whether the working robot 30 has entered the charging area, and then determining whether to activate or deactivate the receiving coil 3441 of the working robot 30.

By providing the coil positioning sensor 3443, the charging module 3440 in this embodiment can solve the problem that the charging module 3440 is prone to position misalignment during use, resulting in low charging efficiency or even no load. Furthermore, the charging module 3440 of this embodiment integrates the positioning function and the wireless charging reception function, and has the advantages of high integration, compact structure and easy installation.

Specifically, please refer to FIGS. 2 and 6 respectively. The charging pile 20 can also include a marking coil 2340, and the coil positioning sensor 3443 can include a pair of inductors 3445 (for example, a coil inductor, a plug inductor, etc.). A pair of inductors 3445 are used to detect the magnetic field strength of the marking coil 2340 so as to determine the position of the charging module 3440 relative to the charging pile 20. It is not difficult to understand here that the marking coil 2340 in the charging pile 20 is in a normally open state to form a marking magnetic field at the location of the charging pile 20. In this embodiment, the distance and angle of the charging module 3440 relative to the charging pile 20 can be determined through the numerical difference of the marking magnetic field obtained by a pair of inductors 3445. If it is recognized that the working robot 30 has traveled to the area above the charging pile 20, the transmitting coil 2320 of the charging pile 20 and the receiving coil 3441 of the working robot 30 are activated to achieve wireless charging of the working robot 30. In some other possible embodiments, the coil positioning sensor 3443 may also be an LC resonant circuit composed of an inductor and a capacitor.

In some possible embodiments, the self-propelled device 340 may also include a control module 3470. Among them, the control module 3470 is installed in the receptacle cavity 3414, and is used to control the motion state of the working robot 30 and control the movement of the working robot 30. Specifically, the control module 3470 may be a controller, such as a Microcontroller Unit (MCU). In some possible embodiments, the control module 3470 may also be provided with a signal amplification circuit (not shown in the figure), which is used to amplify the received signal (for example, electromagnetic wave) to facilitate subsequent signal processing.

The control module 3470 in this embodiment is electrically connected to the coil positioning sensor 3443, and is configured to receive the electromagnetic waves detected by the coil positioning sensor 3443, process the received electromagnetic waves to obtain electromagnetic wave intensity distribution information, and determine the position of the charging module 3440 relative to the charging pile 20 based on the electromagnetic wave intensity distribution information. Wherein, the electromagnetic wave intensity distribution information may be the electromagnetic wave intensity information and the electromagnetic wave range distribution information of the current location of the working robot 30.

In some possible embodiments, the control module 3470 can determine the position offset of the working robot 30 based on the determined position of the charging module 3440 relative to the charging pile 20 and the current motion state of the working robot 30, and correct the motion state of the working robot 30 based on the position offset, so that the working robot 30 can smoothly move to the location of the charging pile 20, thereby effectively avoiding the problem that the working robot 30 cannot accurately find the charging pile 20 when it needs to be charged and effectively improving the charging efficiency of the working robot 30.

The connection between housing 3450 and vehicle body 3410 is explained below.

In some possible embodiments, the housing 3450 may be fixedly connected to the bottom of the vehicle body 3410. Please refer to FIG. 4 again. The housing 3450 can be provided with a charging surface 3451 corresponding to the transmitting coil 2320. The charging surface 3451 protrudes relative to the bottom surface 3412 of the vehicle body 3410, so that when the working robot 30 travels above the charging pile 20, the charging surface 3451 can be closer to the upper surface of the charging pile 20 so as to improve the electromagnetic coupling efficiency with the transmitting coil 2320 in the charging pile 20 and improve the charging efficiency of the working robot 30. Specifically, the “charging surface 3451” here may be the surface of the housing 3450 facing the charging pile 20. As an implementation manner, part of the structure in the housing 3450 (for example, one of the upper housing 3454 or the lower housing 3455) and the vehicle body 3410 can be an integrally molded structure to improve the reliability of the connection between the vehicle body 3410 and the charging module 3440.

In other possible embodiments, the self-propelled device 340 may also include a driving member 3460, which is disposed in the receptacle cavity 3414 and is drivingly connected to the housing 3450. The driving member 3460 is configured to drive the housing 3450 to move within the receptacle cavity 3414 to switch between an extended position and a retracted position. Specifically, the driving member 3460 may be a linear driving member (for example, a linear motor, a cylinder, etc.), and the linear driving member may directly drive the housing 3450 to move up and down in a specified direction. Wherein, the specified direction refers to the direction perpendicular to the plane where the bottom surface 3412 of the vehicle body 3410 is located.

Specifically, the housing 3450 is provided with a charging surface 3451 corresponding to the transmitting coil 2320. When the charging module 3440 is in the extended position, the charging surface 3451 protrudes relative to the bottom surface 3412 of the vehicle body 3410 or is flush with the bottom surface 3412 of the vehicle body 3410; when the charging module 3440 is in the retracted position, the charging surface 3451 is hidden in the receptacle cavity 3414. Wherein, when the charging module 3440 is in the extended position, the charging module 3440 is in a non-charging state. At this time, the charging surface 3451 extends out of the receptacle cavity 3414. When the charging module 3440 is in the retracted position, the charging module 3440 is in the charging state. At this time, the charging surface 3451 retracts into the receptacle cavity 3414.

With such a mechanism design, the housing 3450 is in the extended position when in the non-charging state. When the surface of the charging surface 3451 forms lumps (frost, snow or ice lumps), since the housing 3450 will retract upward into the receptacle cavity 3414 in the charging state, the lumps on the surface of the charging surface 3451 (for example, frost, snow, ice lumps, etc.) will be subject to the normal stress caused by the chassis obstruction of the vehicle body 3410, thereby squeezing each other to fragment and break away from the housing 3450, thus ensuring that when the working robot 30 travels above the charging pile 20, there are no lumps or other debris between the charging surface 3451 and the charging pile 20, ensuring that the working robot 30 can smoothly perform wireless charging, and realizing the intelligence of the working robot 30. In other words, the working robot 30 has the ability to automatically charge in a low-power state, thereby realizing automated work to the maximum extent, so that the working robot 30 does not require manual charging operation.

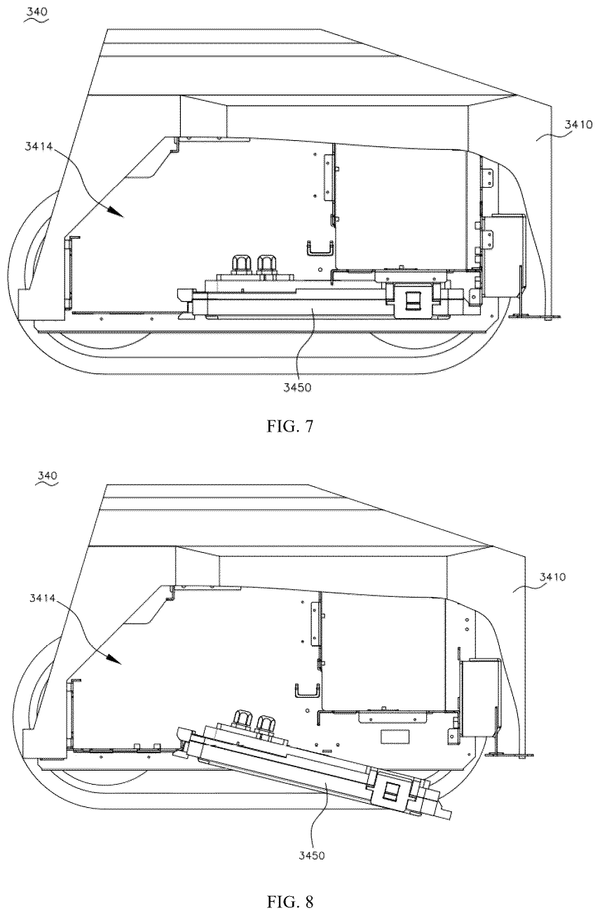

In some further possible embodiments, the housing 3450 is detachably disposed within the receptacle cavity 3414. Please refer to FIGS. 7 and 8 respectively, where FIG. 7 shows the housing 3450 in the installed state and FIG. 8 shows the housing 3450 in the disassembled state. In this embodiment, the self-propelled device 340 may also include a limiting mechanism 3480, which is connected between the housing 3450 and the vehicle body 3410, so that the housing 3450 is detachably connected to the vehicle body 3410. Therefore, when a charging abnormality occurs in the working robot 30, the user or maintenance personnel can quickly disassemble the charging module 3440 from the vehicle body 3410, which improves the convenience of inspection and maintenance.

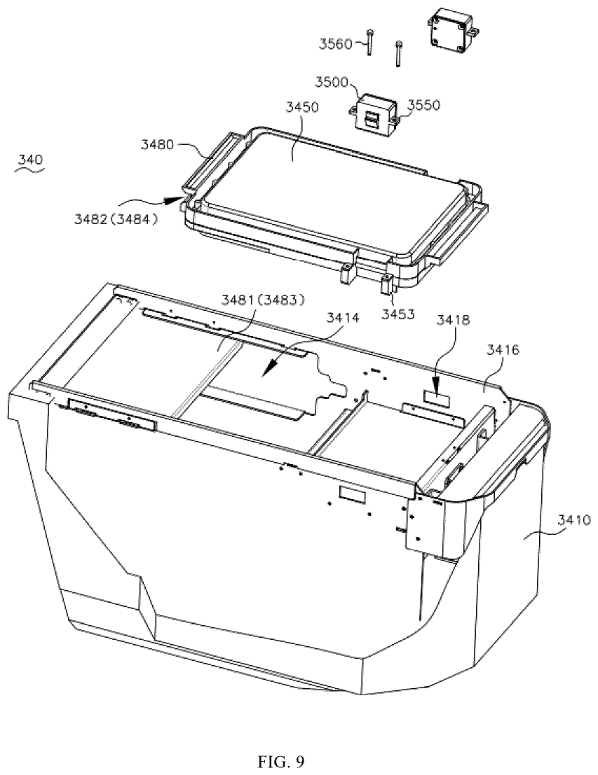

As an implementation, please refer to FIG. 9. The limiting mechanism 3480 may include a first limiting portion 3481 and a second limiting portion 3482. The first limiting portion 3481 and the second limiting portion 3482 are inserted and matched for positioning the housing 3450. Among them, the first limiting portion 3481 is disposed at one end of the receptacle cavity 3414 and connected to the vehicle body 3410, the second limiting portion 3482 is provided on the housing 3450, and the second limiting portion 3482 is limited to the first limiting portion 3481 to fix the installation position of the housing 3450 relative to the vehicle body 3410. Specifically, one of the first limiting portion 3481 and the second limiting portion 3482 is a limiting protrusion 3483, and the other is a limiting groove 3484. The limiting protrusion 3483 is inserted and fitted into the limiting groove 3484.

In the embodiment shown in FIG. 9, the first limiting portion 3481 is a limiting protrusion 3483, and the second limiting portion 3482 is a limiting groove 3484. Specifically, the limiting protrusion 3483 is roughly in the shape of a long strip, which is located at the bottom of the vehicle body 3410 and at one end of the receptacle cavity 3414. The limiting groove 3484 is provided at one end of the housing 3450, and the shape and size of the limiting groove 3484 is consistent with that of the limiting protrusion 3483 to achieve stable retention of one end of the housing 3450. Of course, in some other possible embodiments, the first limiting portion 3481 is a limiting groove 3484, and the second limiting portion 3482 is a limiting protrusion 3483, which is not specifically limited in this application.

In the embodiment shown in FIG. 9, the two sides of the inner wall 3416 of the receptacle cavity 3414 can be provided with the clamping hole 3418, and the limiting mechanism 3480 can also include a lock assembly 3500. The lock assembly 3500 is fixed on both sides of the housing 3450, and elastically engages with the clamping hole 3418 on both sides of the receptacle cavity 3414. The “inner wall 3416 of the receptacle cavity 3414” here may be the side walls located on both sides of the vehicle body 3410 in the direction of travel. Specifically, the above-mentioned second limiting portion 3482 can be disposed at one end of the housing 3450, and two lock assemblies 3500 can be respectively fixed on both sides of the other end of the housing 3450.

Therefore, when the charging module 3440 in this embodiment needs to be installed with the vehicle body 3410, one end of the charging module 3440 is positioned first through the insertion and matching of the first limiting portion 3481 and the second limiting portion 3482. Then, through the snap fit between the lock assembly 3500 and the clamping hole 3418, the other end of the charging module 3440 is locked with the vehicle body 3410, thereby completing the quick installation of the two and improving the installation efficiency of the charging module 3440. When the charging module 3440 needs to be disassembled from the vehicle body 3410, press the lock assembly 3500 on both sides at the same time to unlock, which facilitates subsequent disassembly, inspection and maintenance of the charging module 3440. Compared with the traditional locking method using multiple screws, in this embodiment, the charging module 3440 is fixed by the lock assembly 3500, which can reduce the installation and disassembly steps, improve the disassembly and assembly efficiency of the charging module 3440, and can also prevent the screws from loosening due to the vibration of the vehicle body 3410 of the working robot 30 during walking, and improve the stability of the connection of the charging module 3440.

The specific structure of the lock assembly 3500 and the connection method between the lock assembly 3500 and the housing 3450 are described here.

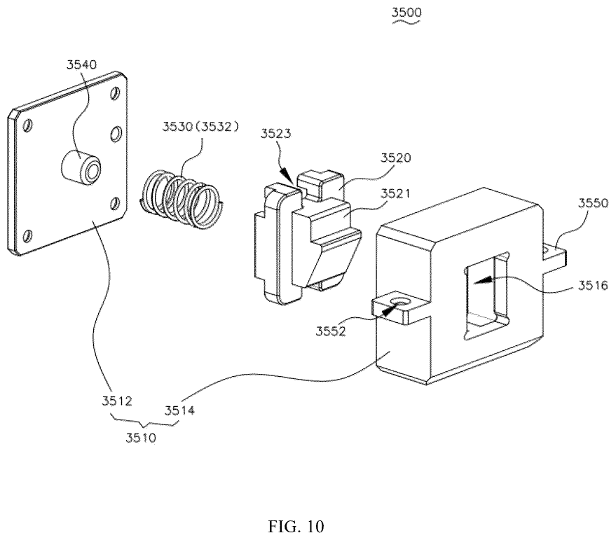

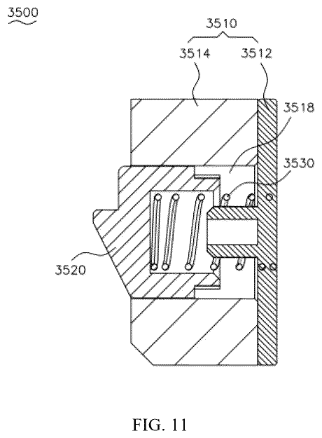

Referring to FIGS. 10 and 11, the lock assembly 3500 may include a shell 3510, a lock tongue 3520 and an elastic member 3530. The shell 3510 is installed on the outside of the housing 3450. The lock tongue 3520 is slidably installed in the shell 3510 and capable of protruding relative to the shell 3510 to engage with the clamping holes 3418, and the elastic member 3530 is disposed between the shell 3510 and the lock tongue 3520. Since the elastic member 3530 in this embodiment is held against between the shell 3510 and the lock tongue 3520, the lock tongue 3520 can move in the deformation direction of the elastic member 3530 to engage with the clamping hole 3418.

Specifically, the shell 3510 may include a support 3512 and a cover 3514, wherein the cover 3514 is connected to the housing 3450 and fixedly connected to the support 3512 to form a chamber for accommodating the lock tongue 3520 and the elastic member 3530. For example, the cover 3514 and the support 3512 may snap together to form the chamber described above. Among them, the cover 3514 is provided with a through hole 3516, and the through hole 3516 penetrates the opposite sides of the cover 3514. The lock tongue 3520 is provided with a clamping part 3521, which can pass through the through hole 3516, movably protrude outside the shell 3510 and engage with the clamping hole 3418.

When the charging module 3440 is pressed into the vehicle body 3410, the lock tongue 3520 of the lock assembly 3500 is in a compressed state. When the lock tongue 3520 reaches the position of the clamping hole 3418, the lock tongue 3520 pops up under the action of the elastic member 3530 and engages with the clamping hole 3418 to lock the charging module 3440 and the vehicle body 3410 together. During disassembly, press the lock tongue 3520 of the lock assembly 3500 on both sides of the body 3410 at the same time, so that the elastic member 3530 is compressed by force, and the lock tongue 3520 is separated from the clamping hole 3418, thereby realizing the separation of the lock assembly 3500 and the clamping hole 3418, and then lift the charging module 3440 to complete the disassembly.

In some possible embodiments, the elastic member 3530 can be a spring 3532, and the lock assembly 3500 also includes a guide post 3540 provided in the shell 3510. The guide post 3540 can be provided on the side of the support 3512 facing the cover 3514, and is fixedly connected to the support 3512, for example, the guide post 3540 and the support 3512 can be an integrally molded structure. Part of the structure of the spring 3532 is sleeved on the outer periphery of the guide post 3540. The guide post 3540 can limit the position of the spring 3532, and can also prevent the spring 3532 from bending and increase the service life of the spring 3532.

In some possible embodiments, one of the shell 3510 and the lock tongue 3520 is provided with a guide platform 3518, and the other is provided with a guide groove 3523. The guide platform 3518 and the guide groove 3523 are movably nested and matched, which can improve smoothness and sliding accuracy of the lock tongue 3520 in the shell 3510. In the embodiment shown in FIG. 10, the guide groove 3523 is provided on the lock tongue 3520, and the guide platform 3518 is provided on the cover 3514. The number of the guide groove 3523 and the guide platform 3518 can be multiple to better limit the moving direction of the lock tongue 3520.

Please refer to FIG. 9 again. The charging module 3440 may also include a fixing platform 3453 provided on the housing 3450. The lock assembly 3500 may also include a lug 3550 provided on the shell 3510. The shell 3510 is connected to the fixing platform 3453 through the lug 3550. Specifically, each lock assembly 3500 may include two lugs 3550 respectively located on opposite sides of the body of the cover 3514. One side of the housing 3450 can be connected with two fixing platforms 3453 corresponding to the two lugs 3550, wherein at least part of the structure of the two fixing platforms 3453 and the housing 3450 can be an integrally molded structure, and the two lugs 3550 and the body of the cover 3514 can be an integrally molded structure.

As an implementation manner, the lugs 3550 are engaged or bonded to the corresponding fixing platform 3453. As another implementation, the lock assembly 3500 may further include a fastener 3560 through which the lug 3550 is connected to the fixing platform 3453. For example, the lug 3550 is provided with a penetration hole 3552, and the fastener 3560 passes through the penetration hole 3552 and is connected to the fixing platform 3453. Specifically, the fastener 3560 may be a pin or a screw.

This embodiment provides a self-propelled device 340, a working robot 30 and a charging system 10. Among them, the self-propelled device 340 is suitable for charging through the charging pile 20. The self-propelled device 340 may include a vehicle body 3410, a traveling mechanism 3420, a battery 3430 and a charging module 3440. Among them, the traveling mechanism 3420 is provided at the bottom of the vehicle body 3410 and is used to drive the body 3410 to move and perform work. The battery 3430 is mounted on the vehicle body 3410. The charging module 3440 is configured to couple with the charging pile 20 to receive electric energy from the charging pile 20 to charge the battery 3430. The charging module 3440 is disposed at the bottom of the vehicle body 3410.

Since the charging module 3440 is disposed at the bottom of the vehicle body 3410, when the working robot 30 is parked at the base 210 of the charging pile 20 for charging, the power module 230 is located below the charging module 3440. Therefore, this application adopts a bottom-up charging structure of the power module 230 and the charging module 3440 and the entire vehicle body 3410 can shield the charging module 3440 located at the bottom of the vehicle body 3410. When the working robot 30 works outdoors in snowy weather, the vehicle body 3410 can prevent snowflakes from falling on the surface of the charging module 3440, thus solving the problem of difficulty in charging caused by snow accumulation or lumps on the surface of the charging module 3440, ensuring that the working robot 30 can successfully complete the charging task.

In the description of this application, certain words are used to refer to specific components, such as in the description and claims. Those skilled in the art will understand that hardware manufacturers may use different names to refer to the same component. This description and the claims do not use differences in names as a means to distinguish between components; rather, differences in functions between the components serve as a criterion for distinction. For example, “including” mentioned in the entire description and claims is an open-ended term, so it should be interpreted as “including but not limited to”; “roughly” means that those skilled in the art can solve the technical problem within a certain range of error and basically achieve technical results.

In the description of this application, it should be understood that the terms “upper”, “lower”, “front”, “back”, “left”, “right”, “inside”, etc. indicate orientation or positional relationships based on the orientation or positional relationships shown in drawings, and are only to simplify the description for the convenience of describing the present application. It does not indicate or imply that the device or component referred to must have a specific orientation and be constructed and operated in a specific orientation, and therefore cannot be understood as a limitation of the present application.

In this application, unless otherwise expressly stated or limited, the terms “installed”, “connected”, “connection”, “fixed” and other terms should be interpreted broadly. For example, it can be a fixed connection, a detachable connection, or an integral connection; it can be a mechanical connection or an electrical connection; it can be a direct connection, an indirect connection through an intermediate medium, an internal connection between two components, or only in surface contact. For those of ordinary skill in the art, the specific meanings of the above terms in this application can be understood according to specific circumstances.

In the description, reference terms such as “one embodiment,” “some embodiments,” “an example,” “specific examples,” or “some examples” means that the specific features, structures, materials or characteristics described in connection with the embodiment or example are included in at least one embodiment or example of the present application. In this description, the schematic expressions of the above terms are not necessarily directed to the same embodiment or example. Furthermore, the specific features, structures, materials or characteristics described may be combined in any one or multiple embodiments or examples in a suitable manner. In addition, in a non-contradictory situation, those skilled in the art may combine and integrate different embodiments or examples as well as features of different embodiments or examples described in this specification.

In addition, the terms “first” and “second” are used for descriptive purposes only and cannot be understood as indicating or implying relative importance or implicitly indicating the quantity of indicated technical features. Therefore, features defined as “first” and “second” may explicitly or implicitly include at least one of these features. In the description of this application, “multiple” means at least two, such as two, three, etc., unless otherwise expressly and specifically limited.

Finally, it should be noted that the above embodiments are only used to illustrate the technical solution of the present application, but not to limit it; although the present application has been described in detail with reference to the foregoing embodiments, those of ordinary skill in the art will understand that: they can still modify the technical solutions described in the foregoing embodiments, or equivalently substitute some of the technical features therein; however, these modifications or substitutions do not cause the essence of the corresponding technical solutions to deviate from the spirit and scope of the technical solutions in the embodiments of the present application.

1. A self-propelled device, characterized in that it is suitable for charging through a charging pile; the self-propelled device includes:
a vehicle body;
a traveling mechanism, provided at the bottom of the vehicle body and used to drive the vehicle body to move and perform work;
a battery, mounted on the vehicle body; and
a charging module, configured to couple with the charging pile to receive electric energy from the charging pile to charge the battery, the charging module being disposed at the bottom of the vehicle body.

2. The self-propelled device according to claim 1, characterized in that the charging pile includes a transmitting coil; the charging module includes a housing and a receiving coil, the housing is installed at the bottom of the vehicle body, and the receiving coil being configured to couple with the transmitting coil, and the receiving coil is disposed within the housing and electrically connected to the battery.

3. The self-propelled device according to claim 2, characterized in that the housing is fixedly connected to the bottom of the vehicle body; the housing is provided with a charging surface corresponding to the transmitting coil, and the charging surface protruding relative to the bottom surface of the vehicle body.

4. The self-propelled device according to claim 2, characterized in that the self-propelled device further includes a driving member;
the bottom of the vehicle body is provided with a receptacle cavity, and the driving member and the housing are arranged in the receptacle cavity; the driving member is drivingly connected to the housing and configured to drive the housing to move within the receptacle cavity, to switch between an extended position and a retracted position;
the housing is provided with a charging surface corresponding to the transmitting coil; when the charging module is in the extended position, the charging surface protrudes relative to the bottom surface of the vehicle body; when the charging module is in the retracted position, the charging surface is hidden in the receptacle cavity.

5. The self-propelled device according to claim 2, characterized in that the bottom of the vehicle body is provided with a receptacle cavity, and the housing is detachably disposed within the receptacle cavity.

6. The self-propelled device according to claim 5, characterized in that the self-propelled device further includes a limiting mechanism, and the limiting mechanism is connected between the housing and the vehicle body, so that the housing is detachably connected to the vehicle body.

7. The self-propelled device according to claim 6, characterized in that the limiting mechanism includes a first limiting portion and a second limiting portion, and the first limiting portion being disposed at one end of the receptacle cavity and connected to the vehicle body, and the second limiting portion being disposed on the housing, and the second limiting portion is limited to the first limiting portion to fix the installation position of the housing relative to the vehicle body.

8. The self-propelled device according to claim 7, characterized in that one of the first limiting portion and the second limiting portion is a limiting protrusion, and the other is a limiting groove, the limiting protrusion is inserted and fitted into the limiting groove.

9. The self-propelled device according to claim 6, characterized in that clamping holes are provided on two sides of the inner wall of the receptacle cavity;
the limiting mechanism also includes a lock assembly, and the lock assembly is fixed on both sides of the housing and elastically engages with the clamping holes on both sides of the receptacle cavity.

10. The self-propelled device according to claim 9, characterized in that the lock assembly includes a shell, a lock tongue and an elastic member, the shell is installed on the outside of the housing, and the lock tongue is slidably installed in the shell and capable of protruding relative to the shell to engage with the clamping holes, the elastic member is disposed between the shell and the lock tongue.

11. The self-propelled device according to claim 10, characterized in that the shell includes a support and a cover, the cover is connected to the housing, the cover is fixedly connected to the support, and the cover is provided with a through hole, and the lock tongue is provided with a clamping part that can pass through the through hole; the clamping part movably protrudes outside the shell and engages with the clamping hole.

12. The self-propelled device according to claim 10, characterized in that the elastic member is a spring, and the lock assembly further includes a guide post provided in the shell, and the spring is sleeved on the guide post.

13. The self-propelled device according to claim 10, characterized in that one of the shell and the lock tongue is provided with a guide platform, and the other is provided with a guide groove, the guide platform and the guide groove are movably nested and matched.

14. The self-propelled device according to claim 10, characterized in that the charging module further includes a fixing platform provided on the housing, and the lock assembly further includes a lug provided on the shell, the shell is connected to the fixing platform through the lug.

15. The self-propelled device according to claim 14, characterized in that the lug is engaged or bonded to the fixing platform, or
the lock assembly further includes a fastener, and the lug is connected to the fixing platform through the fastener.

16-17. (canceled)

18. The self-propelled device according to claim 2, characterized in that the charging module further includes a coil positioning sensor, being disposed within the housing, and the coil positioning sensor is configured to detect the position of the charging module relative to the charging pile.

19. The self-propelled device according to claim 18, characterized in that the charging pile further includes a marking coil, and the coil positioning sensor includes a pair of inductors, and the pair of inductors is used to detect the magnetic field strength of the marking coil so as to determine the position of the charging module relative to the charging pile.

20. The self-propelled device according to claim 18, characterized in that the self-propelled device further includes a control module, the control module being electrically connected to the coil positioning sensor, and configured to receive the electromagnetic waves detected by the coil positioning sensor, process the received electromagnetic waves to obtain electromagnetic wave intensity distribution information, and determine the position of the charging module relative to the charging pile based on the electromagnetic wave intensity distribution information.

21-23. (canceled)

24. A working robot, characterized by including:
a working device; and
the self-propelled device according to claim 1, wherein the working device is connected to the vehicle body of the self-propelled device;
wherein the working device further includes at least one of a snow removal mechanism, a snow rolling mechanism, a snow throwing mechanism, a weeding mechanism, a mowing mechanism, a leaf blowing mechanism, a salt spreading mechanism, a rolling brush mechanism and a snow pushing mechanism.

25. (canceled)

26. A charging system, characterized in that it includes:
a working robot according to claim 24; and
a charging pile, wherein the charging pile includes a base and a power module, and the power module is arranged on the base and is adapted to the charging module of the working robot;
the base is used for parking the working robot, when the working robot is parked at the base for charging, the power module is located below the charging module.
